(19) United States
(12) Patent Application Publication
(10) Pub. No.: US 2010/0323313 A1
(43) Pub. Date: Dec. 23, 2010

(54) STAGE STRUCTURE AND HEAT TREATMENT APPARATUS

(75) Inventors: Daisuke Toriya, Yamanashi-ken (JP); Hirohiko Yamamoto, Yamanashi-ken (JP)

Correspondence Address: SMITH, GAMBRELL & RUSSELL, 1130 CONNECTICUT AVENUE, N.W., SUITE 1130, WASHINGTON, DC, 20036, US

(73) Assignee: TOKYO ELECRON LIMITED, TOKYO-TO (JP)

(21) Appl. No.: 12/918,244

(22) PCT Filed: Mar. 13, 2009
(86) PCT No.: PCT/JP2009/054937

§ 371 Date: Aug. 18, 2010

(30) Foreign Application Priority Data
Mar. 21, 2008 (JP) 2008-072725

(51) Int. Cl. F27B 5/16; B23Q 3/00

(52) U.S. Cl. 432/200; 269/289 R

(57) ABSTRACT

There is provided a stage structure which can prevent the formation of a cool spot in the central portion of a stage, thereby preventing breakage of the stage, and can enhance the in-plane uniformity of heat treatment of a processing object.

The stage structure, provided in a treatment container of a heat treatment apparatus, for placing thereon a semiconductor wafer W as a processing object to be heat treated, includes: a stage 52 for placing the processing object on it; and a cylindrical support post 54 jointed to the center of the lower surface of the stage and supporting the stage. A heat reflecting section 56 is provided at an upper position within the support post and close to the lower surface of the stage. The use of the heat reflecting section 56 prevents the formation of a cool spot in the central portion of the stage 54.

### TECHNICAL FIELD

The present invention relates to a heat treatment apparatus and a stage structure for carrying out a predetermined heat treatment of a processing object, such as a semiconductor wafer.

### BACKGROUND ART

In the manufacturing of a semiconductor integrated circuit, a processing object such as a semiconductor wafer is generally subjected to repetition of various treatments, such as film formation, etching, heat treatment, reforming, crystallization, etc. to form a desired integrated circuit. When carrying out such various treatments, a treatment gas necessary for an intended treatment, for example, a film-forming gas and a halogen gas for film formation, ozone gas, etc. for reforming, or an inert gas such as N₂ gas, O₂ gas, etc. for crystallization, is introduced into a treatment container.

In the case of a one-by-one type heat treatment apparatus which carries out heat treatment of semiconductor wafers in a one-by-one manner, a stage, e.g. having a built-in resistance heater, is installed in an evacuable treatment container, and a semiconductor wafer is placed on the upper surface of the stage and heated to a predetermined temperature (e.g. 100° C. to 1000° C.) while a predetermined treatment gas is introduced into the treatment container. In this manner various heat treatments can be carried out on a semiconductor wafer under respective predetermined process conditions (patent documents 1 to 5). Members in the treatment container are thus required to possess heat resistance to a heat treatment temperature and corrosion resistance to a treatment gas so that they will not corrode when exposed to the gas.

For a stage structure for placing a semiconductor wafer on it, it is generally necessary to provide it with heat resistance and corrosion resistance and, in addition, to prevent it from causing metal contamination. In conventional practice, therefore, a ceramic material such as AlN, for example, is subjected to burning at a high temperature together with a resistance heater as a heating element embedded in the ceramic material, thereby integrally forming a stage. In a separate process, a ceramic material, for example, is subjected to burning to form a support post. The stage and the support post, thus formed, are welded and integrated e.g. by thermal diffusion bonding to produce a stage structure. The integrated stage structure is provided upright on the bottom of a treatment container. In some cases, quartz glass having heat resistance and corrosion resistance is used instead of a ceramic material.

An exemplary conventional stage structure will now be described. FIG. 10 is a cross-sectional diagram illustrating an exemplary conventional stage structure. The stage structure is provided in an evacuable treatment container and, as shown in FIG. 10, includes a disk-shaped stage 2 made of a ceramic material, such as AlN. A cylindrical support post 4, also made of a ceramic material such as AlN, has been bonded, e.g. by thermal diffusion bonding, to the central portion of the lower surface of the stage 2 and is thus integrated with the stage 2. The stage 2 and the support post 4 are thus hermetically bonded at a thermal diffusion joint 6.

In the case of a 300 mm semiconductor wafer, for example, the diameter of the stage 2 is about 350 mm and the diameter of the support post 4 is about 50 to 60 mm. A heating means 8, e.g. comprised of a heater, is provided within the stage 2 to heat a semiconductor wafer W as a processing object on the stage 2.

The lower end of the support post 4 is mounted by fixing blocks 10 to the container bottom 9, so that the support post 4 is held upright. Connecting terminals 12 for the heating means 8 are provided e.g. in a hole in the center of the lower surface of the stage 2. Inside the cylindrical support post 4 are provided power feed rods 14 whose upper ends are connected to the connecting terminals 12 of the heating means 8 and whose lower ends penetrate through an insulating member 16 provided in the container bottom and extend downwardly outside the container. Such construction of the stage structure can prevent intrusion of a corrosive treatment gas, etc. into the support post 4, thereby preventing corrosion of the power feed rods 14, the connecting terminals 12, etc. by the treatment gas.

Patent document 1: Japanese Patent Laid-Open Publication No. 63-278322

Patent document 2: Japanese Patent Laid-Open Publication No. 07-078766
Patent document 3: Japanese Patent Laid-Open Publication No. 06-260430
Patent document 4: Japanese Patent Laid-Open Publication No. 2004-356624
Patent document 5: Japanese Patent Laid-Open Publication No. 2006-295138

The stage 2 is brought into a high-temperature state upon processing of a semiconductor wafer. The support post 4 is made of a ceramic material whose thermal conductivity is not so high. However, because the stage 2 and the support post 4 have been bonded by thermal diffusion, there is an unavoidable escape of a large amount of heat from the central portion of the stage 2 into the support post 4.

Therefore, the temperature of the central portion of the stage 2 becomes low especially upon raising and lowering of the temperature of the stage 2, whereby a cool spot is formed, whereas the temperature of the peripheral portion is high. Thus, a large temperature difference is produced in the surface of the stage 2. Consequently, concentration of a large thermal stress will occur in the central portion of the stage 2, which can cause cracking or even breakage of the stage 2.

Further, due to the formation of the cool spot, a temperature difference is produced in a semiconductor wafer W placed on the stage 2, thus lowering the in-plane uniformity of the temperature distribution in the semiconductor wafer W. This will result in lowering of the in-plane uniformity of heat treatment, leading to variation in the thickness of a film produced. FIG. 11 is a diagram illustrating an exemplary temperature distribution in the surface of the stage 2.

The Figure shows a temperature distribution as observed when a film-forming treatment is carried out at a process temperature of 650° C., with the isotherms being at intervals of 2° C. As can be seen from the data, the temperature of the stage 2 is lowest in the central portion and a cool spot is formed there, and there is a maximum temperature difference of about 23° C. in the surface of the stage 2.

Though depending on the type of processing, the temperature of the stage 2 can reach 700° C. or higher, which forms a considerably large temperature difference in the stage 2. In addition, repetition of raising and lowering of the temperature of the stage 2 can promote the above-described breakage of the stage 2 due to thermal stress.

### DISCLOSURE OF THE INVENTION

The present invention addresses the above problems and has been made to effectively solve the problems. It is therefore an object of the present invention to provide a stage structure and a heat treatment apparatus which can prevent the formation of a cool spot in the central portion of a stage, thereby preventing breakage of the stage, and can enhance the in-plane uniformity of heat treatment of a processing object.

Thus, the present invention provides a stage structure, provided in a treatment container of a heat treatment apparatus, for placing thereon a processing object to be heat treated, comprising: a stage for placing the processing object on it; a cylindrical support post coupled to the center of the lower surface of the stage and supporting the stage; and a heat reflecting section provided at an upper position within the support post and close to the lower surface of the stage.

In the stage structure provided in a treatment container of a heat treatment apparatus, the heat reflecting section is provided at an upper position within the cylindrical support post that supports the stage and close to the lower surface of the stage. The heat reflecting section can reflect back radiant heat emitted from the central portion of the lower surface of the stage. This can prevent the formation of a cool spot in the central portion of the stage, thereby preventing breakage of the stage, and can enhance the in-plane uniformity of heat treatment of a processing object.

The heat reflecting section is, for example, comprised of one heat reflecting plate or a plurality of heat reflecting plates arranged in multiple stages.

The heat reflecting plate is, for example, comprised of a heat insulating plate and a heat reflecting layer provided on the upper surface of the heat insulating plate.

The heat reflecting plate, for example, comprises a metal plate or a metal layer.

The metal plate is, for example, made of a material selected from the group consisting of copper, aluminum, aluminum alloy, gold and stainless steel.

The heat insulating plate is, for example, made of a ceramic material.

The heat reflecting section is, for example, supported by a support rod disposed in an upright position on the bottom of the treatment container.

For example, the stage is provided with a heating means for heating the processing object and a power feed rod for feeding power to the heating means is provided within the support post, and the support rod is formed in a pipe-like shape and the power feed rod is inserted into the support rod.

For example, the stage is provided with a stage electrode and a power feed rod for feeding power to the stage electrode is provided within the support post, and the support rod is formed in a pipe-like shape and the power feed rod is inserted into the support rod.

The support rod is, for example, made of a metal or a ceramic material.

The heat reflecting section is, for example, supported on the inner wall of the support post.

The present invention also provides a heat treatment apparatus for carrying out a predetermined heat treatment of a processing object, comprising: an evacuable treatment container; a stage structure provided to place the processing object on it in the treatment container; a heating means for heating the processing object; and a gas introduction means for introducing a gas into the treatment container, wherein the stage structure comprises: a stage for placing the processing object on it; a cylindrical support post coupled to the center of the lower surface of the stage and supporting the stage; and a heat reflecting section provided at an upper position within the support post and close to the lower surface of the stage.

The stage structure and the heat treatment apparatus according to the present invention can achieve the following advantageous effects:

In the stage structure provided in the treatment container of the heat treatment apparatus, the heat reflecting section is provided at an upper position within the cylindrical support post that supports the stage and close to the lower surface of the stage. The heat reflecting section can reflect back radiant heat emitted from the central portion of the lower surface of the stage. This can prevent the formation of a cool spot in the central portion of the stage, thereby preventing breakage of the stage, and can enhance the in-plane uniformity of heat treatment of a processing object.

### BRIEF DESCRIPTION OF THE DRAWINGS

FIG. 1 is a diagram showing the construction of a heat treatment apparatus using a stage structure according to the present invention;

FIG. 2 is a partially enlarged perspective view schematically showing a portion of the stage structure;

FIG. 3 is a cross-sectional view schematically showing the stage structure;

FIG. 4 is an enlarged cross-sectional view schematically showing the joint between a stage and a support post;

FIG. 5 is an exploded perspective view showing exemplary support rods that support heat reflecting plates;

FIG. 6 is a graph showing the relationship between the wavelength of a heat wave (light) and emissivity/absorptance;

FIG. 7 is an enlarged cross-sectional view showing the structure of a first variation of heat reflecting section;

FIG. 8 is a diagram showing the structure of a second variation of heat reflecting section;

FIG. 9 is a partially enlarged cross-sectional view showing the structure of a third variation of heat reflecting section;

FIG. 10 is a cross-sectional view showing an exemplary conventional stage structure; and

FIG. 11 is a diagram illustrating an exemplary temperature distribution in the surface of a stage.

### BEST MODE FOR CARRYING OUT THE INVENTION

Preferred embodiments of the stage structure and the heat treatment apparatus of the present invention will now be described in detail with reference to the drawings.

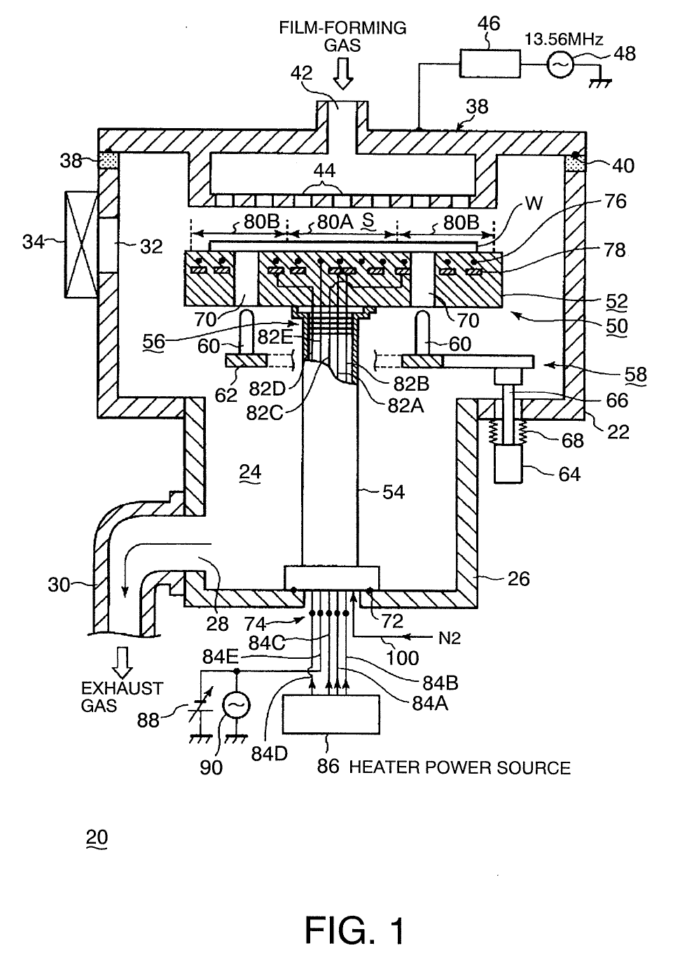

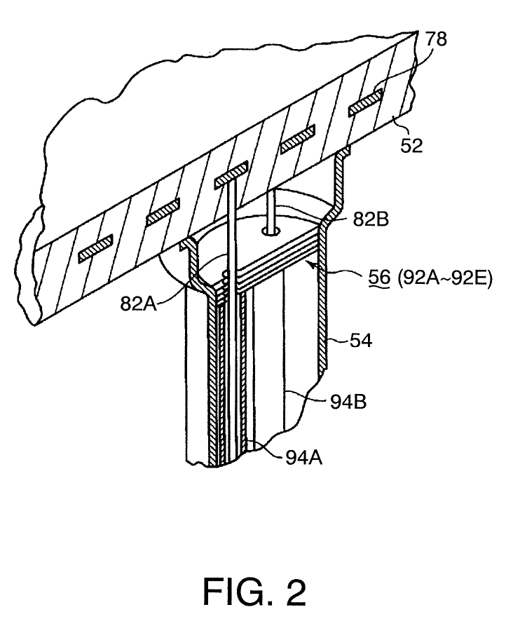

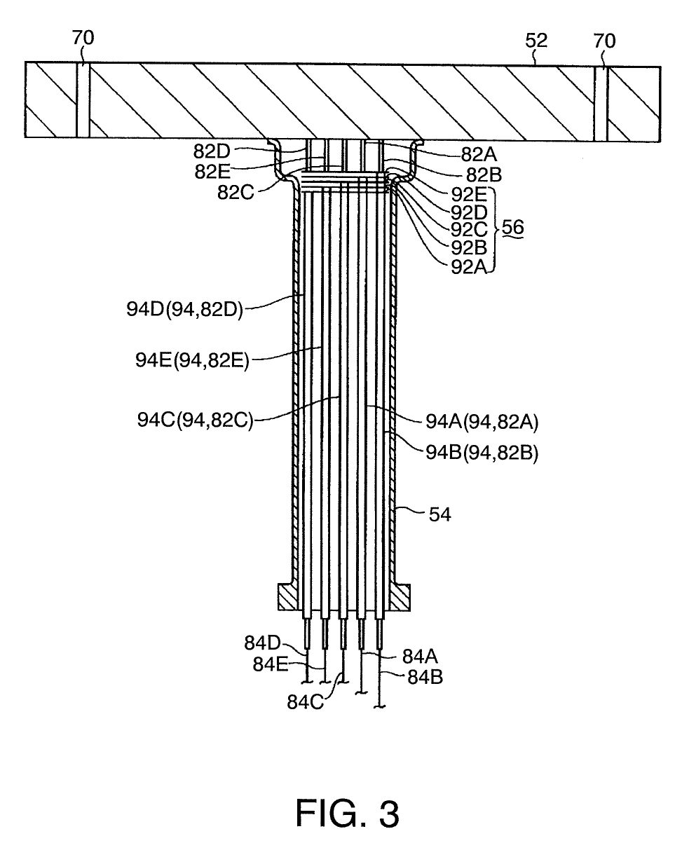

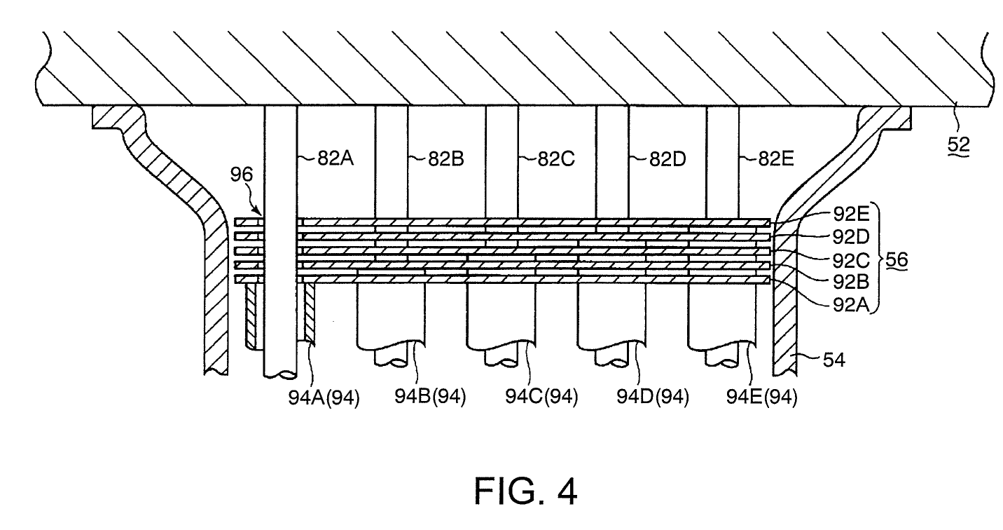

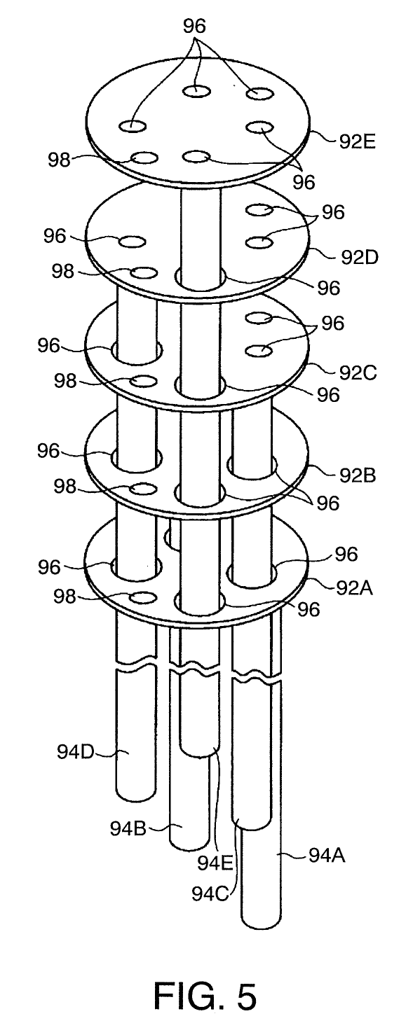

FIG. 1 is a diagram showing the construction of a heat treatment apparatus using a stage structure according to the present invention; FIG. 2 is a partially enlarged perspective view schematically showing a portion of the stage structure; FIG. 3 is a cross-sectional view schematically showing the stage structure; FIG. 4 is an enlarged cross-sectional view schematically showing the joint between a stage and a support post; and FIG. 5 is an exploded perspective view showing exemplary support rods that support heat reflecting plates.

A parallel flat-plate type of plasma heat treatment apparatus is herein illustrated as an exemplary heat treatment apparatus. As shown in FIG. 1, the heat treatment apparatus 20 includes a treatment container 22 made of e.g. an aluminum alloy and formed in a cylindrical shape. A recessed exhaust space 24 is defined by a bottomed cylindrical compartment wall 26 provided centrally in the bottom of the treatment container 22. The bottom of the compartment wall 26 constitutes part of the container bottom. An exhaust port 28 is provided in the side wall of the compartment wall 26. An exhaust pipe 30 in which a pressure regulating valve, a vacuum pump, etc., not shown, are interposed is connected to the exhaust port 28 so that the treatment container 22 can be evacuated to a desired pressure. In some types of heat treatments, heat treatment may be carried out at atmospheric pressure without using plasma.

A transfer port 32 for transfer of a semiconductor wafer W as a processing object is formed in the side wall of the treatment container 22, and a gate valve 34 is provided at the transfer port 32. The gate valve 34 is opened/closed upon transfer of the semiconductor wafer W.

The ceiling of the treatment container 22 is open, and a shower head 38 as a gas introduction means is provided in the opening via an insulating member 36. A sealing member 40, such as an O-ring, is interposed between the shower head 38 and the insulating member 36 in order to keep the container hermetically closed. A gas introduction port 42 is provided at the top of the shower head 38, and a plurality of gas injection holes 44 are provided in the lower gas injection surface of the shower head 38, so that a necessary treatment gas can be injected into a treatment space S. Though in this embodiment the shower head 38 has one interior space, it is also possible to use a shower head having a plurality of divided interior spaces to supply different gases separately into the treatment space S without mixing the gases in the shower head.

The shower head 38 also functions as an upper electrode for plasma generation. In particular, a high-frequency power source 48 for plasma generation is connected via a matching circuit 46 to the shower head 38. An exemplary, non-limitative frequency of the high-frequency power source 48 is 13.56 MHz.

In the treatment container 22 is provided a stage structure 50 according to the present invention for placing a semiconductor wafer W on it. The stage structure 50 includes a generally disk-shaped stage 52 for placing the semiconductor wafer W directly on its upper wafer-receiving surface, a cylindrical support post 54 for supporting the stage 52 in a position raised from the container bottom, and a heat reflecting section 56, a characteristic portion of the present invention, provided at an upper position within the support post 54.

Below the stage 52 is provided a lifting pin mechanism 58 which supports the semiconductor wafer W by pushing it from below upon transfer of the wafer W. The lifting pin mechanism 58 includes, for example, three, lifting pins 60 (only two pins are shown) arranged at equal intervals in the circumferential direction of the stage 52, the lower end of each lifting pin 60 being supported on a base plate 62, e.g. having an arc shape. The base plate 62 is coupled to a lifting rod 66 which penetrates through the container bottom and is vertically movable by means of an actuator 64. Positioned under the through-hole of the container bottom, through which the lifting rod 66 penetrates, is provided a flexible bellows 68 to permit the vertical movement of the lifting rod 66 while keeping the container hermetically closed.

The stage 52 is provided with pin insertion holes 70 each corresponding to each lifting pin 60. The lifting pins 60, inserted into the pin insertion holes 70, move into and out of the wafer-receiving surface by vertically moving the lifting rod 66, so that the lifting pins 60 can move the semiconductor wafer W vertically.

The entire stage 52 and the entire support post 54 are formed of a material which will not cause metal contamination and has excellent heat resistance, such as a ceramic material or quartz. In this embodiment the support post 54 is formed in a cylindrical shape and has been hermetically bonded to the central portion of the lower surface of the stage 52 e.g. by thermal diffusion bonding or welding. The lower end of the support post 54 is mounted, e.g. by not-shown bolts, to a portion around an opening 74 formed in the container bottom via a sealing member 72, such as an O-ring, to keep the container hermetically closed. Aluminum nitride (AlN), aluminum oxide (Al₂O₃), silicon carbide (SiC), quartz (SiO₂), etc. can be used as the ceramic material.

Chuck electrodes 76 of an electrostatic chuck as stage electrodes and a heater section 78 as a heating means are embedded in the stage 52. A carbon wire heater, for example, can be used as the heater section 78. The chuck electrodes 76 are provided immediately under the wafer-receiving surface to attract and hold the semiconductor wafer W by electrostatic force. The heating section 78 is provided below the chuck electrodes 76 to heat the semiconductor wafer W.

In this embodiment the chuck electrodes 76 are used also as lower electrodes for plasma. Besides the above-described materials, high-melting metals or their compounds or alloys may be used for the chuck electrodes 76 and the heater section 78. Examples of usable high-melting metals include W, Mo, V, Cr, Mn, Nb, Ta, etc. Mo or W, or an alloy thereof may be used principally.

The heater section 78 is electrically separated into a plurality of heating zones, for example, two concentric heating zones, an inner heating zone 80A and an outer heating zone 80B, as in this embodiment. Temperature control can be performed for each heating zone. Thus, two power feed rods 82A, 82B are connected to those portions of the heater section 78 which correspond to the inner heating zone 80A, and two power feed rods 82C, 82D are connected to those portions of the heater section 78 which correspond to the outer heating zone 80B, so that power controls for the respective zones can be performed individually. A power feed rod 82E is connected to the chuck electrodes 76 which also serve as the lower electrodes.

In FIG. 2, only the two power feed rods 82A, 82B for the inner heating zone 80A of the heater section 78 are representatively depicted. In FIGS. 1, 3 and 4, for the sake of easier understanding, the arrangement of the power feed rods 82A to 82E is laterally expanded though they are centrally concentrated in the actual arrangement.

The power feed rods 82A to 82E are inserted into the cylindrical support post 54 and extends downwardly from the opening 74 of the container bottom. The power feed rods 82A to 82D for the heater section 78 are connected to a heater power source 86 via lines 84A, 84B, 84C and 84D, respectively. The power feed rod 82E for the chuck electrodes 76 is connected via a line 84E to a direct-current power source 88 and to a high-frequency bias power source 90. Though not shown diagrammatically, the stage 52 is also provided with a rod-shaped thermocouple for temperature measurement, inserted into the support post 54.

As described above, the heat reflecting section 56 is provided at an upper position within the support post 54 and close to the central portion of the lower surface of the stage 52. More specifically, as shown in FIGS. 2 to 4, the heat reflecting section 56 is comprised of a plurality of heat reflecting plates, for example, five heat reflecting plates 92A, 92B, 92C, 92D, 92E, arranged in multiple stages at a predetermined pitch.

The heat reflecting plates 92A to 92E are designed such that the diameter is slightly smaller than the inner diameter of the support post 54 and the thickness is about 0.5 to 2.0 mm to make the heat capacity of each plate small. The heat reflecting plates 92A to 92E are arranged in the vertical direction e.g. at a pitch of about 1.2 mm. The heat reflecting plates 92A to 92E are each comprised of e.g. a metal plate, such as a copper plate, and reflect radiant heat from the stage 52, positioned above the heat reflecting plates, so that the reflected heat will be directed toward the stage 52. A material selected from the group consisting of copper, aluminum, an aluminum alloy, gold and stainless steel may be used for the metal plate.

The heat reflecting plates 92A to 92E are supported by support rods 94 disposed within the support post 54 and upright on the bottom of the treatment container 22. In particular, as shown in FIG. 5, the support rods 94 consists of five support rods 94A, 94B, 94C, 94D, 94E, corresponding to the heat reflecting plates 92A to 92E. The support rods 94A to 94E support the heat reflecting plates 92A to 92E, respectively.

The support rods 94A to 94E are each formed in a pipe-like (cylindrical) form and, the corresponding heat reflecting plates 92A to 92E to be supported are jointed to the upper ends of the support rods e.g. by welding. The above-described power feed rods 82A to 82E are inserted into the pipe-shaped support rods 94A to 94E, respectively.

The heat reflecting plates 92A to 92E each have insertion holes 96 for insertion of the support rods 94A to 94E or the power feed rods 82A to 82E. The insertion holes 96 are designed such that those holes which allow insertion of only the power feed rods 82A to 82E have a small diameter, and those holes which allow insertion of the support rods 94A to 94E have a large diameter. The heat reflecting plates 92A to 92E each also have a thermocouple insertion hole 98 for insertion of a not-shown rod-shaped thermocouple (see FIG. 5). The thermocouple insertion holes 98 all have the same diameter.

The pipe-shaped support rods 94A to 94E are made of a metal or a ceramic material. When the pipe-shaped support rods 94A to 94E are made of a metal, a sufficient space should be ensured in each support rod to avoid short circuit between the support rods 94A to 94E and the power feed rods 82A to 82E inserted in the support rods. The above-described metals usable for the heat reflecting plates 92A to 92E can also be used for the power feed rods 82A to 82E.

Returning to FIG. 1, an inert gas such as N₂ is introduced by an inert gas supply section 100 into the cylindrical support post 54, having the above-described construction, in order to prevent oxidation of the metal surfaces of the above-described members. Besides N₂ gas, a rare gas such as Ar can also be used as the inert gas.

The operation of the heat treatment apparatus 20 thus constructed will now be described.

First, an untreated semiconductor wafer W, held by a not-shown transport arm, is carried in the treatment container 22 through the gate valve 34 in the open state and the transfer port 32. The semiconductor wafer W is transferred onto the lifting pins 60, and then the lifting pins 60 are lowered to place and then support the semiconductor wafer W on the upper surface of the stage 52 of the stage structure 50.

Next, a treatment gas, e.g. a film-forming gas, is supplied at a controlled flow rate and the gas is injected from the gas injection holes 44 to introduce the gas into the treatment space S. The treatment container 22 and the exhaust space 24 are evacuated by continuously driving the not-shown vacuum pump provided in the exhaust pipe 30, and the atmosphere of the treatment space S is kept at a predetermined process pressure through adjustment of the degree of opening of the pressure regulating valve. The temperature of the semiconductor wafer W is kept at a predetermined process temperature. Thus, a voltage is applied from the heater power source 86 to the heater section 78 via the power feed rods 82A to 82D to heat the heater section 78, thereby heating the entire stage 52.

Consequently, the substrate wafer W on the stage 52 is heated to the predetermined temperature. The temperature of the semiconductor wafer W is measured with the not-shown thermocouple provided in the stage 52, and the wafer temperature is controlled based on the measurement.

On the other hand, in order to carry out plasma treatment, the high-frequency power source 48 is activated to apply high frequency between the shower head 38 as an upper electrode and the stage 52 as a lower electrode, thereby generating plasma in the treatment space S. At the same time, a voltage is applied to the chuck electrodes 76, constituting an electrostatic chuck, so as to attract the semiconductor wafer W to the stage 52. The semiconductor wafer W is then subjected to a predetermined plasma treatment. During the treatment, plasma ions can be attracted to the wafer by applying high frequency from the high-frequency bias power source 90 to the chuck electrodes 76 of the stage 52.

Under such process conditions, heat is likely to be conducted from the central portion of the stage 52 by heat transfer though the support post 54 connected to the lower surface of the stage 52. In this regard, in the conventional stage structure, a cool spot of a low temperature will be formed in the central portion of the stage. In contrast, according to the present invention, the formation of a cool spot in the central portion of the stage 52 can be prevented by the use of the heat reflecting section 56 which reflects radiant heat.

In particular, the heat reflecting section 56, e.g. consisting of the five heat reflecting plates 92A to 92E made of metal, is disposed close to the central portion of the lower surface of the stage 52. Radiant heat emitted from the central portion of the lower surface of the stage 52 is reflected off the five heat reflecting plates 92A to 92E, provided in multiple stages, and the reflected heat returns to the stage 52 and reheats it. Therefore, unlike the conventional stage structure, the formation of a cool spot in the central portion of the stage 52 can be prevented, making it possible to enhance the in-plane uniformity of the temperature of the stage 52. The heat reflecting plates 92A to 92E are each very thinly formed to make their heat capacity small, and therefore the plates do not have an adverse thermal effect on the stage 52.

The distance between the lower surface of the stage 52 and the heat reflecting plates 92A to 92E is preferably as small as possible. For example, the distance between the lower surface of the stage 52 and the uppermost heat reflecting plate 92E may preferably be not more than 5 mm. Though the number of the heat reflecting plates is not specifically limited, it is preferably in the range of 1 to 5 in view of the overall heat capacity and the effect of reflecting radiant heat.

Because the interior of the cylindrical support post 54 is kept in an atmosphere of an inert gas, e.g. N₂ gas, not only corrosion of the power feed rods 82A to 82E can be prevented, but corrosion of the heat reflecting plates 92A to 92E made of metal can also be prevented.

Thus, in the stage structure 50 provided in the treatment container 22 of the heat treatment apparatus 20, the heat reflecting section 56, e.g. consisting of the heat reflecting plates 92A to 92E, is provided at an upper position within the cylindrical support post 54 that supports the stage 52 and close to the lower surface of the stage 52. The heat reflecting section 56 can reflect back radiant heat emitted from the central portion of the lower surface of the stage 52. This can prevent the formation of a cool spot in the central portion of the stage 52, thereby preventing breakage of the stage 52, and can enhance the in-plane uniformity of heat treatment of the semiconductor wafer W as a processing object.

<Evaluation of Materials for the Heat Reflecting Plates 92A to 92E>

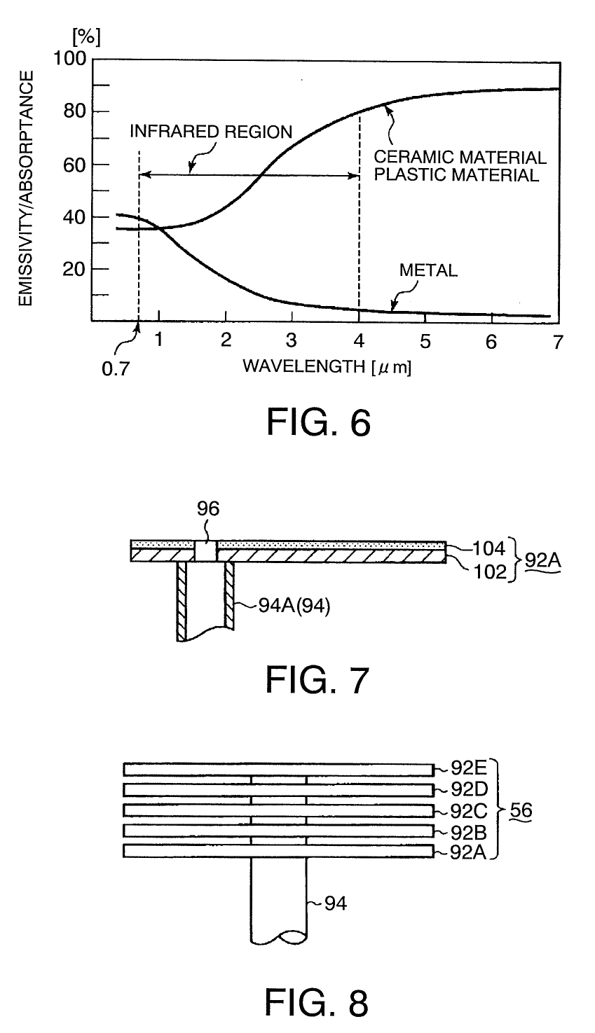

A description will now be given of a study made on materials for the heat reflecting plates 92A to 92E. A metal, a ceramic material and a plastic material were evaluated as a material for the heat reflecting plates 92A to 92E. The results are shown in FIG. 6. FIG. 6 is a graph showing the relationship between the wavelength of a heat wave (light) and the emissivity/absorptance.

In FIG. 6, the wavelength of the near-infrared rays of radiant heat is within the range of about 0.7 to 4 μm. A ceramic material and a plastic material have a high emissivity/absorptance in the above wavelength range, whereas a metal has a relatively low emissivity/absorptance, indicating reflection of a larger amount of radiant heat. It will therefore be understood from the data that a metal is preferred as a material for the heat reflecting plates 92A to 92E.

<Determination of the Amount of Heat Emitted from the Stage>

A description will now be given of a simulation which was performed to determine the amount of heat (heat energy) emitted from the stage 52 into the support post 54.

In the simulation, aluminum nitride (AlN) was used for the stage 52, and one copper heat reflecting plate was used as the heat reflecting section 56. The temperature of the stage 52 was set at 680° C. (=953K), and the temperature of the heat reflecting plate was varied as follows: 600° C., 500° C., 400° C. and 300° C.

The coefficient fε of heat emission of the stage 52 can be calculated as follows:

fε=1/[(1/ε1)+(1/ε2)−1]=0.20
ε1: emissivity of stage 52 (=0.9)
ε2: emissivity of heat reflecting plate (=0.2)

The effective area of the stage 52 is “0.00180864 m²”.

The radiant energy E of the stage 52 can be calculated as follows:

E=fε·σ·(T1⁻⁴−T2⁻⁴)
σ: Stefan-Boltzmann constant (=5.67×10⁻⁸ W/m²·K⁴)
T1: temperature of stage 52
T2: temperature of heat reflecting section (heat reflecting plate) 56

The amount of heat transferred from the stage 52 (radiant energy E), calculated from the above equations, is 4.9 W (watt) when the temperature of the heat reflecting section is 600° C., 9.4 W when the temperature is 500° C., 12.4 W when the temperature is 400° C., and 14.4 W when the temperature is 300° C. On the other hand, in the case of the conventional stage structure, the calculated radiant energy E is 76.1 W.

As can be seen from the above results, according to the stage structure of the present invention, the amount of heat transferred from the stage 52 into the support post 54 can be significantly reduced in the tested temperature range of 300 to 600° C. as compared to the conventional stage structure.

<Variations of the Heat Reflecting Section>

Variations of the heat reflecting section 56 will now be described. FIG. 7 is an enlarged cross-sectional view showing the structure of a first variation of the heat reflecting section. The same reference numerals are used for the same components as those shown in FIGS. 1 through 6, and a description thereof will be omitted.

Though in the above-described embodiment the heat reflecting plates 92A through 92E, constituting the heat reflecting section 56, are each composed of a metal plate, each heat reflecting plate may be composed of a heat insulating plate and a heat reflecting layer. Thus, in this variation, the heat reflecting plate 92A is composed of a thin heat insulating plate 102 and a heat reflecting layer 104 provided on the upper surface of the heat insulating plate 102, as shown in FIG. 7.

FIG. 7 representatively illustrates the one heat reflecting plate 92A. The other heat reflecting plates 92B to 92E also have the same construction. A thin plate-like ceramic material, for example, may be used as the heat insulating plate 102. A thin metal layer, for example, may be used as the heat reflecting layer 104. The above-described materials usable for the heat reflecting metal plate, i.e. a material selected from the group consisting of copper, aluminum, an aluminum alloy, gold and stainless steel, may be used for the metal layer.

Such a metal layer can be formed, e.g. by plating or sputtering, on the heat insulating plate 102 composed of a plate-like ceramic material. According to this variation, radiant heat from the stage 52 can be reflected while suppressing heat transfer from the stage 52. This variation can achieve the same advantageous effects as the embodiment described above with reference to FIGS. 1 through 6.

FIG. 8 is a diagram showing the structure of a second variation of the heat reflecting section. Though in the above-described embodiment one heat reflecting plate is supported by one support rod, a plurality of heat reflecting plates may be supported by one support rod. In the variation shown in FIG. 8, the five heat reflecting plates 92A to 92E, constituting the heat reflecting section 56, are supported by one pipe-shaped support rod 94.

In this case, one of the five power feed rods 82A to 82E is inserted into the pipe-shaped support rod 94. This variation can achieve the same advantageous effects as the embodiment described above with reference to FIGS. 1 through 6 and, in addition, can decrease the number of support rods 94.

Though in the above-described embodiments pipe-shaped (hollow) support rods are used as the support rods 94, 94A to 94E, it is also possible to use solid support rods. Though in the above-described embodiments the heat reflecting plates 92A to 92E, constituting the heat reflecting section 56, are supported by the support rods 94A to 94E, this manner is not imitative of the present invention.

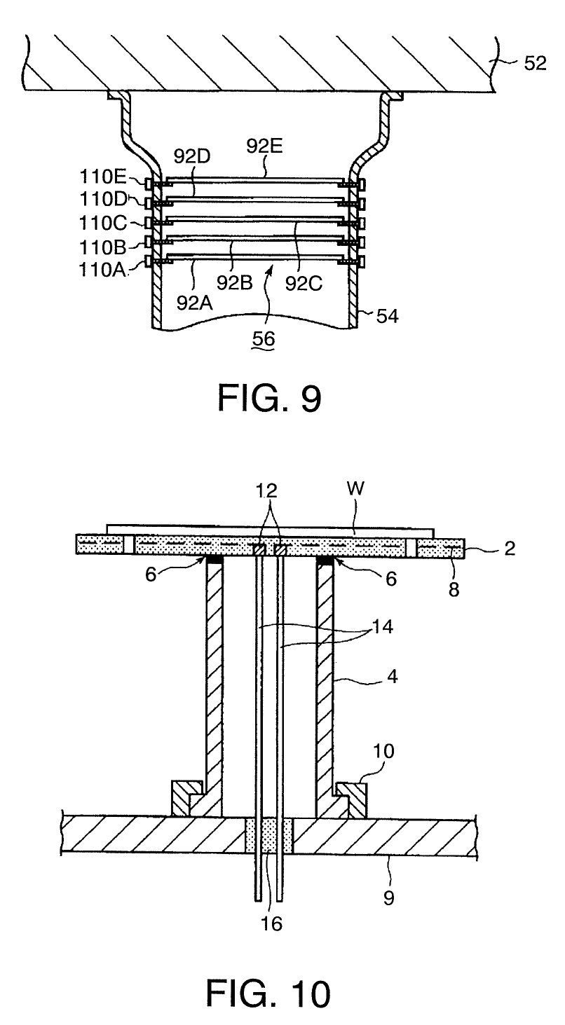

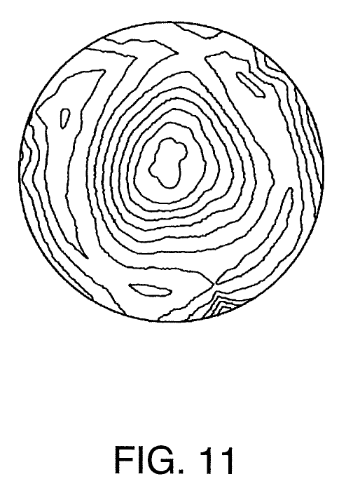

For example, it is possible to use the manner of the third variation of the heat reflecting section, shown in FIG. 9. In particular, a plurality of support pins, e.g. ceramic support pins 110A to 110E, are inserted into the support post 54 from its outer surface such that the support pins are arranged in multiple stages within the support post 54. The peripheral portions of the heat reflecting plates 92A to 92E are placed and supported on the front end portions of the support pins 110A to 110E, respectively. This variation can achieve the same advantageous effects as the embodiment described above with reference to FIGS. 1 through 6 and, in addition, can decrease the number of support rods 94.

In the above-described embodiments, a ceramic material can be used for the support rods 94, 94A to 94E, the heat insulating plate 102, etc. A material selected form the group consisting of alumina (Al₂O₃), aluminum nitride (AlN), silicon carbide (SiC) and silicon nitride (SiN), may be used as the ceramic material.

While a film-forming treatment using plasma has been described by way of example, the present invention can be applied to any heat treatment, such as thermal CVD film formation using no plasma, thermal diffusion, reforming, crystallization, etching, etc.

While the present invention has been described with reference to the case in which the heating means 78 is embedded in the stage 52, it is possible, for example, to use a heat lamp as the heating means 78 and to provide the heat lamp on the ceiling portion of the treatment container 22, facing the stage 52. In this case, not a shower head but a gas nozzle or the like, penetrating the side wall of the treatment container 22, is used as the gas introduction means 38.

Further, while the use of a semiconductor wafer as a processing object has been described, the present invention can be applied to other types of processing objects, such as a glass substrate, an LCD substrate, a ceramic substrate, etc.

1. A stage structure, provided in a treatment container of a heat treatment apparatus, for placing thereon a processing object to be heat treated, comprising:
a stage for placing the processing object on it;
a cylindrical support post jointed to the center of the lower surface of the stage and supporting the stage; and
a heat reflecting section provided at an upper position within the support post and close to the lower surface of the stage.

2. The stage structure according to claim 1, wherein the heat reflecting section is comprised of one heat reflecting plate or a plurality of heat reflecting plates arranged in multiple stages.

3. The stage structure according to claim 2, wherein the heat reflecting plate is comprised of a heat insulating plate and a heat reflecting layer provided on the upper surface of the heat insulating plate.

4. The stage structure according to claim 3, wherein the heat reflecting plate comprises a metal plate or a metal layer.

5. The stage structure according to claim 4, wherein the metal plate is made of a material selected from the group consisting of copper, aluminum, aluminum alloy, gold and stainless steel.

6. The stage structure according to claim 3, wherein the heat insulating plate is made of a ceramic material.

7. The stage structure according to claim 1, wherein the heat reflecting section is supported by a support rod disposed in an upright position on the bottom of the treatment container.

8. The stage structure according to claim 7, wherein the stage is provided with a heating means for heating the processing object and a power feed rod for feeding power to the heating means is provided within the support post, and wherein the support rod is formed in a pipe-like shape and the power feed rod is inserted into the support rod.

9. The stage structure according to claim 7, wherein the stage is provided with a stage electrode and a power feed rod for feeding power to the stage electrode is provided within the support post, and wherein the support rod is formed in a pipe-like shape and the power feed rod is inserted into the support rod.

10. The stage structure according to claim 7, wherein the support rod is made of a metal or a ceramic material.

11. The stage structure according to claim 1, wherein the heat reflecting section is supported on the inner wall of the support post.

12. A heat treatment apparatus for carrying out a predetermined heat treatment of a processing object, comprising:
an evacuable treatment container;
a stage structure provided to place the processing object on it in the treatment container;
a heating means for heating the processing object; and
a gas introduction means for introducing a gas into the treatment container, wherein the stage structure comprises: a stage for placing the processing object on it; a cylindrical support post jointed to the center of the lower surface of the stage and supporting the stage; and a heat reflecting section provided at an upper position within the support post and close to the lower surface of the stage.
